(19) United States
(12) Patent Application Publication
(10) Pub. No.: US 2014/0001344 A1
(43) Pub. Date: Jan. 2, 2014

(54) SWITCHED MODE NIGHT VISION DEVICE POWER SUPPLY

(71) Applicant: Todd L. Lewis, San Diego, CA (US)

(72) Inventor: Todd L. Lewis, San Diego, CA (US)

(73) Assignee: EPC Power, San Diego, CA (US)

(21) Appl. No.: 13/540,408

(22) Filed: Jul. 2, 2012

(51) Int. Cl. H01J 43/04

(52) U.S. Cl. 250/214 LA

(57) ABSTRACT

A night vision device with a switching power supply and a method of powering a night vision device with switching circuits are provided. The switching power supply converts a battery voltage to high DC voltages for powering photocathode, screen, and MCP of the night vision device. The switching power supply generates and adjusts a photocathode voltage instruction signal having a duty cycle based on the difference between a reference photocathode voltage and the output voltage of the photocathode voltage circuit. The switching power supply generates and adjusts a screen voltage instruction signal having a duty cycle based on the difference between a reference screen voltage and the output voltage of the screen voltage circuit. The switching power supply performs the automatic brightness control and auto-gating without directly sensing the output load current.

### FIELD OF THE INVENTION

The present invention relates generally to night vision devices, and more particularly, to night vision devices with switched mode power supplies.

### BACKGROUND OF THE INVENTION

Night vision devices are optical instruments that allow images to be produced in levels of light approaching total darkness. Such devices are commonly used by the military and law enforcement agencies. Night vision devices amplify light to form images, and allow a user to easily see through the darkness. These devices usually refer to a complete unit including an image intensifier tube and a power supply. The image intensifier tube absorbs the surrounding light, converts the light into electronic patterns, changes them into light discernible by a user, and transmits the light to a photosensitive screen. There are several generations of image intensifier tubes.

An image intensifier tube comprises different components. For example, an image intensifier tube usually includes a micro-channel plate (MCP), which is a planar component used for detection of particles, e.g., electrons or ions, and impinging radiation, e.g., ultraviolet radiation and X-rays. An MCP intensifies single particles or photons by the multiplication of electrons via secondary emission. In addition, an image intensifier tube also includes a screen which displays the output of the image intensifier tube. Phosphor is commonly used on the inside surface of the screen to produce the image. Different phosphors are used on the inside surface of the screen of different image intensifier tubes. Further, an image intensifier tube includes a photocathode, which is a negatively charged electrode that emits electrons when struck by a quantum of light. Optionally, a plain metallic cathode is coated with specialized coating that increases the photoelectric effect. As a result, photocathodes of different intensifier tubes have different coatings as well as different photocathode materials.

Night vision devices require high voltage power supplies that transform low direct circuit (DC) voltage to one or different levels of high DC voltages depending on the voltage requirements of various components of a night vision device. One battery or more 1.5V to 3V batteries are typically used to power the device. Typically, two N-cell or two “AA” batteries are used. Power supplies convert the battery voltage to a high DC voltage, e.g. 5000V, to power the image intensifier tube. Different components of the image intensifier tube may require different levels of high DC voltages. Current generations of night vision device power supplies utilize oscillators, combined with high voltage transformers and voltage multipliers, to produce high voltage DC output to light the image intensifier tube. Sinusoidal oscillators produce input to voltage multipliers, which boost and rectify the signal, and subsequently produce high DC voltages to power the night vision device. However, this solution is physically large and all the output voltages move together rather than independently. Additionally, analog oscillators are sensitive to temperature and part tolerance, and thus are difficult to build consistently in volume.

Further, because different night vision devices comprise different components that may have different voltage requirements, transformers are then application-customized because the requisite turns-ratio may vary for different night vision devices. Because a night vision device's screen resolution can be adjusted by altering the photocathode voltage (even for night vision devices using the same screen), different transformers are needed for powering different night vision devices operating the same screen at different resolutions. As a result, conventional solutions are extremely expensive. Moreover, transformers are inefficient, have high losses, and generate heat. Often, transformers are implicated as the point of failure in product returns.

In addition, night vision tube power supplies deliver Nanoampere(nA) scale currents to the tube, which needs to be sensed in order to provide control. In current designs, this output current is either estimated, or sensed directly using resistors and operational amplifiers (OpAmps.) Nevertheless, the estimation is ineffective and sensing using resistors and OpAmps adds to the overall cost and complexity of power supplies for night vision devices.

### BRIEF SUMMARY OF EMBODIMENTS OF THE INVENTION

Embodiments of the present invention are directed toward a switched mode design of night vision tube power supplies. By utilizing a switched mode design, low cost commercially available inductors replace transformers to generate the high voltage pulses needed for the voltage multipliers. The topology is physically smaller and has a lower cost as it accommodates all needs of different night vision devices comprising different image intensifier tubes.

According to various embodiments of the present invention, separate switching circuits generate the photocathode voltage, the MCP voltage, and the screen voltage. Output voltages of the switching circuits vary from 0V to the maximum output, and thus capable of accommodating various voltage needs of different image intensifier tubes of different night vision devices.

According to one embodiment of the present invention, a night vision device comprises an image intensifier tube and a switching power supply which comprises a first switching system generating a photocathode voltage and comprising a first switch for turning on and off a first input voltage in response to a first instruction signal; a second switching system generating a micro-channel plate (MCP) voltage and comprising a second switch for turning on and off a second input voltage in response to a second instruction signal; a third switching system generating a screen voltage and comprising a third switch turning on and off a third input voltage in response to a third instruction signal; and a drive voltage regulator converting a battery voltage to the first input voltage, the second input voltage, and the third input voltage.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention.

FIG. 1 depicts a diagram of an exemplary night vision device employing an exemplary switched mode power supply, in accordance with an embodiment of the present invention.

FIG. 2 depicts a diagram of an exemplary switching photocathode voltage circuit, in accordance with an embodiment of the present invention.

FIG. 3A depicts a diagram of an exemplary switching MCP voltage circuit, in accordance with an embodiment of the present invention.

FIG. 3B depicts a diagram of an exemplary switching MCP voltage circuit, in accordance with an embodiment of the present invention.

FIG. 4 depicts a diagram of an exemplary switching screen voltage circuit, in accordance with an embodiment of the present invention.

FIG. 5A depicts a diagram of exemplary switching photocathode voltage circuit with voltage feedback and switching screen voltage circuit with voltage feedback, in accordance with an embodiment of the present invention.

FIG. 5B depicts a diagram of exemplary switching photocathode voltage circuit with voltage feedback and switching screen voltage circuit with voltage feedback, in accordance with an embodiment of the present invention.

FIG. 6A illustrates a diagram of an exemplary switching voltage circuit with automatic brightness control, in accordance with an embodiment of the present invention.

FIG. 6B illustrates a diagram of an exemplary switching voltage circuit with auto-gating control, in accordance with an embodiment of the present invention.

FIG. 7 illustrates a flow chart of an exemplary method of powering a night vision device using switching circuits, in accordance with an embodiment of the present invention.

These figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention.

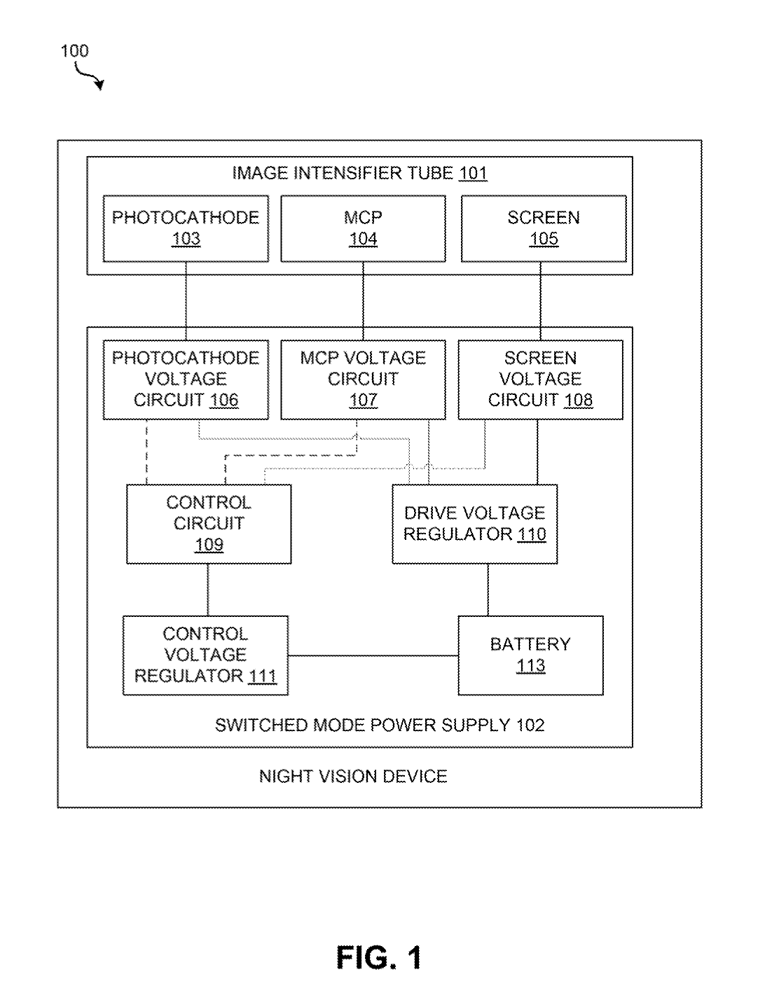

FIG. 1 depicts a diagram of an exemplary night vision device 100 employing an exemplary switched mode power supply 102, in accordance with an embodiment of the present invention. The night vision device 100 includes an image intensifier tube 101, which includes a photocathode 103, a micro-channel plate (MCP) 104, and a screen 105. The battery 113 of the switched mode power supply 102 powers the night vision device 100. In one embodiment, one or more AA batteries may be used as battery 113. A drive voltage regulator 110 converts the output voltage of the battery 113 to one or more regulated voltages to power the photocathode voltage circuit 106, the MCP voltage circuit 107, and the screen voltage circuit 108. In one embodiment, the photocathode voltage circuit 106, MCP voltage circuit 107, and the screen voltage circuit 108 are all powered at 30V provided by the drive voltage regulator 110.

The switched mode power supply 102 also includes a photocathode voltage circuit 106, a MCP voltage circuit 107, and a screen voltage circuit 108. In one embodiment, the photocathode voltage circuit 106, the MCP voltage circuit 107, and the screen voltage circuit 108 are all switching resonant circuits. The photocathode voltage (output of the photocathode voltage circuit 106) powers the photocathode 103; the MCP voltage (output of the MCP voltage circuit 107) powers the MCP 104; and the screen voltage (output of the screen voltage circuit 108) powers the screen 105. In one embodiment, either one or two AA batteries are used and the photocathode voltage, MCP voltage, and the screen voltage rise to maximums of −2100V, −1200V, and 4800V, respectively.

Still referring to FIG. 1, in one embodiment, the photocathode voltage circuit 106, the MCP voltage circuit 107, and the screen voltage circuit 108 may be controlled by a control circuit 109. Control electronics of the control circuit 109 are powered by the output of the control voltage regulator 111, which converts the battery voltage to a regulated control voltage.

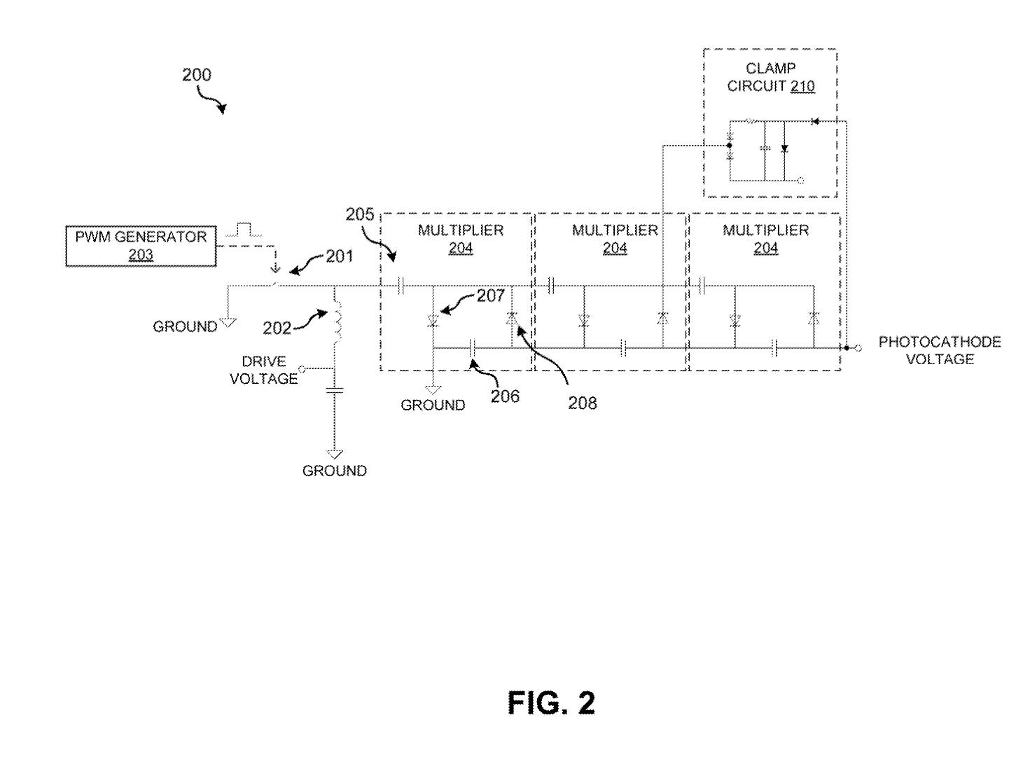

FIG. 2 depicts a diagram of an exemplary switching photocathode voltage circuit 200, in accordance with an embodiment of the present invention. In one embodiment, the switch 201 is a field-effect transistor (FET). The gate of the switch 201 may be driven by a pulse-width modulation (PWM) generator 203. A drive voltage (output of the drive voltage regulator 110) powers the switching photocathode voltage circuit 200. A single stage negative multiplier 203 includes two capacitors 205, 206 and two diodes 207, 208. Multiple stages of multiplier 203 can be connected in series to generate a high DC voltage output. In one embodiment, three stages of multiplier 203 are connected in series in the switching photocathode voltage circuit. The drive voltage charges the inductor 202 by building up the current through the inductor 202 when the switch 201 closes. The current through the inductor 202 resonates with the multiplier chain when the switch 201 opens, which in turn creates a high DC voltage output. The photocathode voltage (output of the switching photocathode voltage circuit) is proportional to the duty cycle of the switch 201. In one embodiment, a DC voltage clamp circuit 210 is provided on the output of the photocathode voltage circuit for high light conditions. The DC voltage clamp circuit 210 may include a Zener diode.

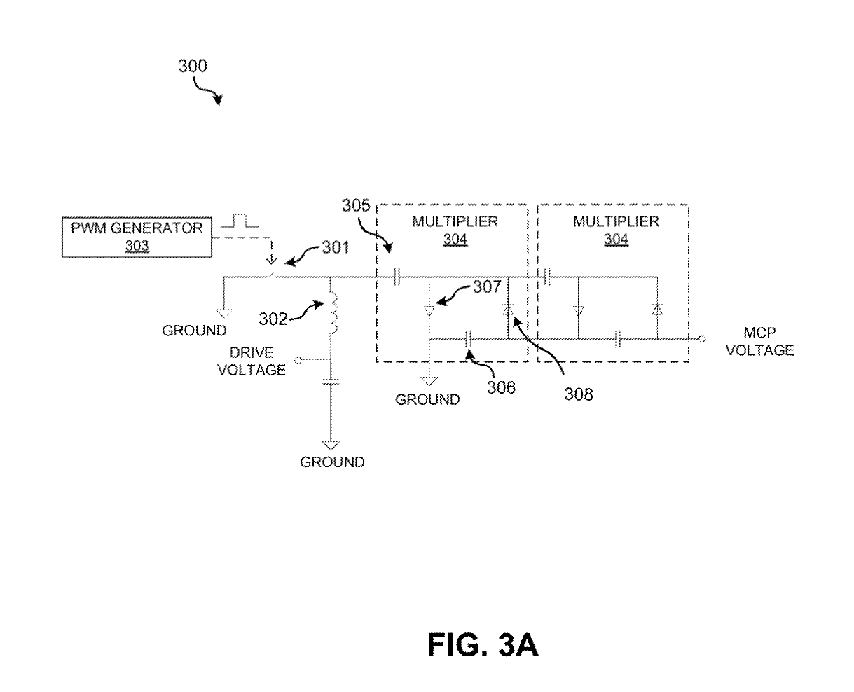

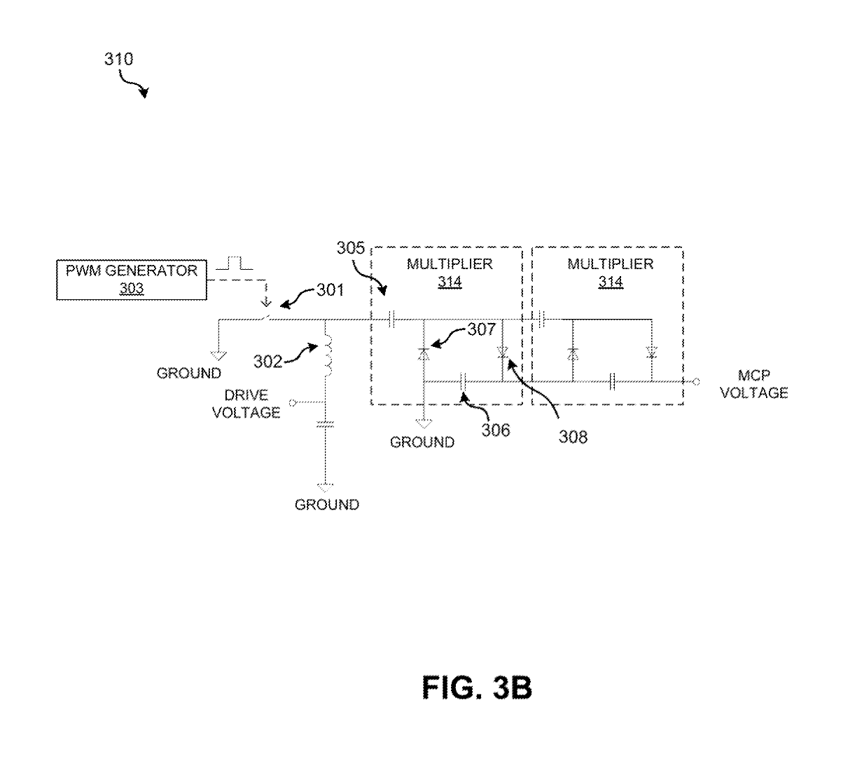

FIG. 3A depicts a diagram of an exemplary switching MCP voltage circuit 300, in accordance with an embodiment of the present invention. In one embodiment, the switch 301 is a FET. The gate of the switch 301 may be driven by a PWM generator 303. A drive voltage (output of the drive voltage regulator 110) powers the switching MCP voltage circuit 300. A single stage negative multiplier 304 includes two capacitors 305, 306 and two diodes 307, 308. Multiple stages of multiplier 304 can be connected in series to generate a high DC voltage output. In one embodiment, two stages of multiplier 304 are connected in series in the switching MCP voltage circuit. The drive voltage charges the inductor 302 by building up the current through the inductor 302 when the switch 301 closes. The current through the inductor 302 resonates with the multiplier chain when the switch 301 opens, which in turn creates a high DC voltage output. The MCP voltage (output of the switching MCP voltage circuit) is proportional to the duty cycle of the switch 301.

FIG. 3B depicts a diagram of an exemplary switching MCP voltage circuit 310, in accordance with an embodiment of the present invention. In one embodiment, the switch 301 is a FET. The gate of the switch 301 may be driven by a PWM generator 303. A drive voltage (output of the drive voltage regulator 110) powers the switching MCP voltage circuit 310. A single stage positive multiplier 314 includes two capacitors 305, 306 and two diodes 307, 308. Multiple stages of multiplier 314 can be connected in series to generate a high DC voltage output. In one embodiment, two stages of multiplier 314 are connected in series in the switching MCP voltage circuit. The drive voltage charges the inductor 302 by building up the current through the inductor 302 when the switch 301 closes. The current through the inductor 302 resonates with the multiplier chain when the switch 301 opens, which in turn creates a high DC voltage output. The MCP voltage (output of the switching MCP voltage circuit) is proportional to the duty cycle of the switch 301.

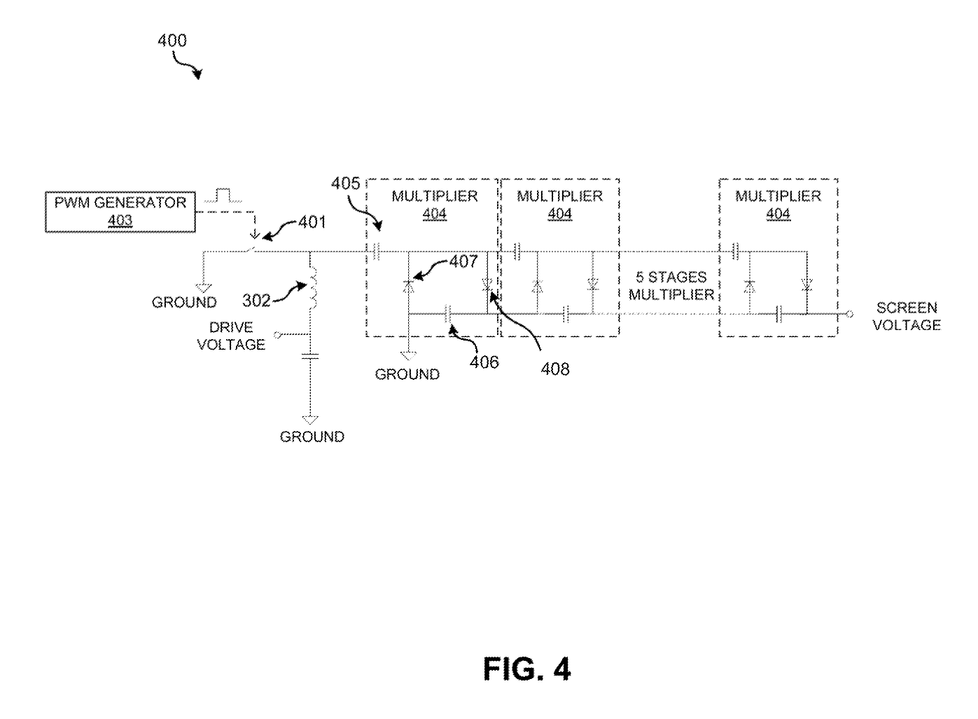

FIG. 4 depicts a diagram of an exemplary switching screen voltage circuit 400, in accordance with an embodiment of the present invention. In one embodiment, the switch 401 is a FET. The gate of the switch 401 is driven by a PWM generator 403. A drive voltage, output of the drive voltage regulator 110, powers the switching screen voltage circuit 400. A single stage positive multiplier 404 includes two capacitors 405, 406 and two diodes 407, 408. Multiple stages of multiplier 404 can be connected in series to generate a high DC voltage output. In one embodiment, a total of eight stages of multiplier 404 are connected in series in the switching screen voltage circuit. Because the screen voltage is positive whereas the photocathode voltage is negative, the multiplier 404 is a positive multiplier whereas the multipliers 204 is a negative multiplier. In various embodiments, a negative multiplier 304 or a positive multiplier 314 can be used in the switching MCP voltage circuit. The drive voltage charges the inductor 402 by building up the current through the inductor 402 when the switch 401 closes. The current through the inductor 402 resonates with the multiplier chain when the switch 401 opens, which in turn creates a high DC voltage output. The screen voltage (output of the switching screen voltage circuit) is proportional to the duty cycle of the switch 401.

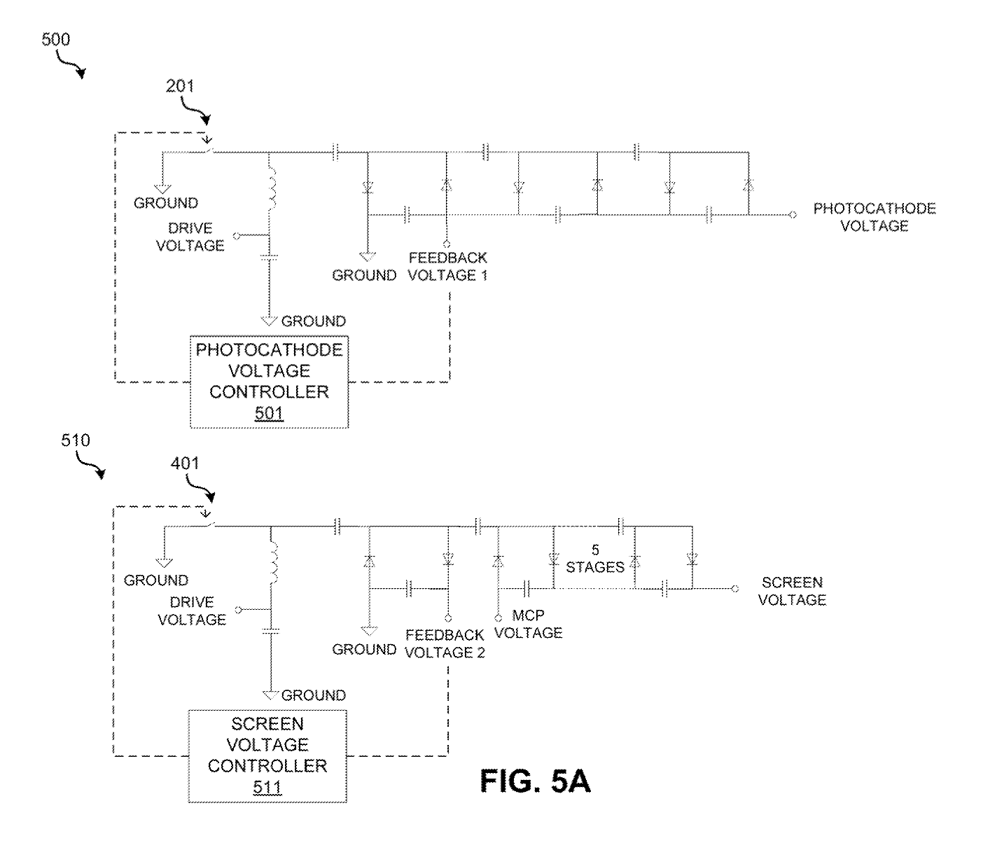

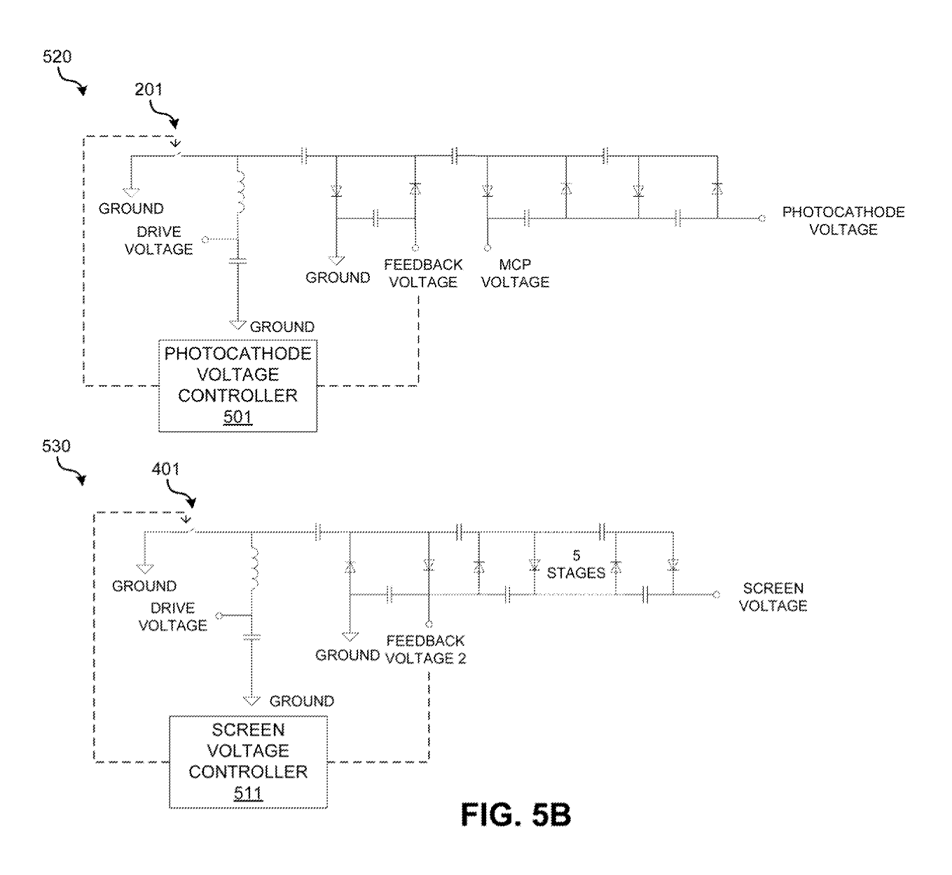

FIG. 5A depicts a diagram of exemplary switching photocathode voltage circuit 500 with voltage feedback and switching screen voltage circuit 510 with voltage feedback, in accordance with an embodiment of the present invention. In one embodiment, output voltage of the first stage multiplier of each circuit is used as the feedback voltage reference. In one embodiment where there are three stages of multiplier in the photocathode voltage circuit, the output voltage of the first stage multiplier equals to one third (⅓) of the photocathode voltage. The switch 201 opens and closes according to an instruction signal created by a photocathode voltage controller 501, which compares the feedback voltage 1 to a reference voltage for the photocathode voltage circuit. If the feedback voltage 1 is lower than the reference voltage, then the controller will increase the duty cycle of the instruction signal to switch 201 to increase the output photocathode voltage. If the feedback voltage 1 is higher than the reference voltage, then the controller will decrease the duty cycle of the instruction signal to switch 201 to decrease the output photocathode voltage.

The output photocathode voltage is continuously variable from 0V to the maximum voltage. The maximum voltage is determined by the number of multiplier stages. In one embodiment, a user may select the output photocathode voltage level or the resolution level which is adjusted by altering the photocathode. Higher resolution requires higher photocathode voltage level but draws more power from the battery. The photocathode voltage controller 501 may include a PWM generator.

In FIG. 5A, there are eight stages of multiplier in the screen voltage circuit, the output voltage of the first stage multiplier equals to one eighth (⅛) of the screen voltage. The switch 401 opens and closes according to an instruction signal created by a screen voltage controller 511, which compares the feedback voltage 2 to a reference voltage for the screen voltage circuit. The screen voltage controller 511 may include a PWM generator. Both the switching photocathode voltage circuit 500 and the switching screen voltage circuit 510 are resonant circuits of which the output power is fixed; thus, when each of the feedback voltage 1 and feedback voltage 2 is controlled to a constant value, the photocathode voltage controller and the screen voltage controller will adjust proportionally with the load current, respectively. This allows for the automatic brightness control as well as auto-gating control loops to be implemented without directly sensing the output load current (including the screen current and photocathode current) or the multiplier current. In one embodiment, one control circuitry performs the functions of both the photocathode voltage controller 501 and the screen voltage controller 511.

Still referring to FIG. 5A, the photocathode voltage is referenced to the ground while the screen voltage is referenced to the MCP voltage. In one embodiment, the switching MCP voltage circuit is implemented with positive voltage multipliers. This configuration eases the implementation of auto-gating control by referencing the photocathode voltage to ground.

FIG. 5B depicts a diagram of exemplary switching photocathode voltage circuit 520 with voltage feedback and switching screen voltage circuit 530 with voltage feedback, in accordance with an embodiment of the present invention. The photocathode voltage is referenced to the MCP voltage while the screen voltage is referenced to the ground. In one embodiment, the switching MCP voltage circuit is implemented with negative voltage multipliers. This configuration will result in a lesser screen voltage. A user may select the reference point for the photocathode voltage circuit and the screen voltage circuit.

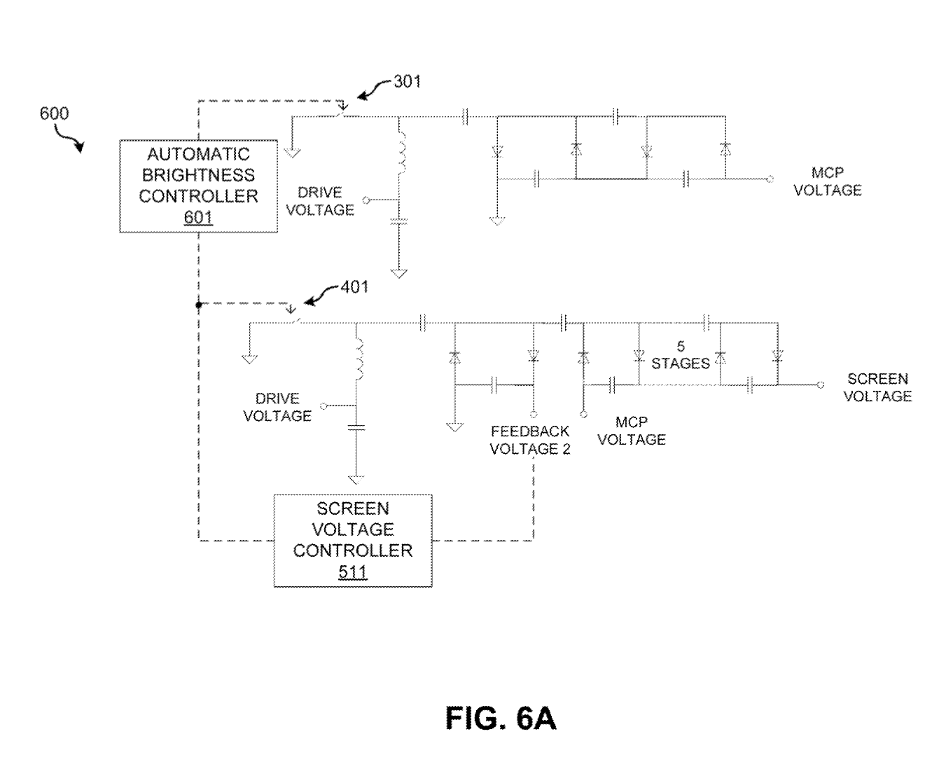

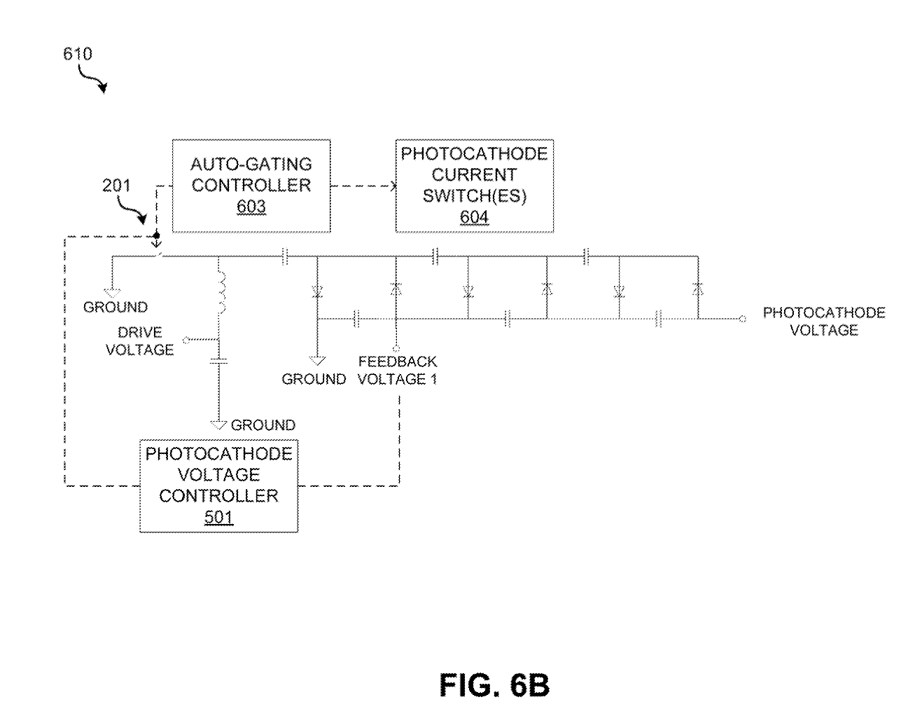

FIG. 6A illustrates a diagram of an exemplary switching voltage circuit 600 with automatic brightness control, in accordance with an embodiment of the present invention. The screen current, output of the screen voltage controller, is controlled to a constant value by controlling the MCP voltage. The switching voltage circuit 500 comprises a MCP voltage circuit and a screen voltage circuit. The output of the screen voltage controller 511, which is also the gate signal to the switch 401 of the screen voltage controller, is proportional to the output load current. The switch 301 opens and closes according to an instruction signal created by an automatic brightness controller 601, which compares the output of the screen voltage controller 511 to a set point. When the output load current is greater than the set point, the automatic brightness controller 601 will reduce the duty cycle of the switch 401 to maintain the output brightness of the screen below the set point. A user can select and program the set point for the night vision device. Further, when the output load current equals to or is lower than the set point, the automatic brightness controller 601 defaults the output brightness of the screen to the set point.

In FIG. 6A, the voltage multiplier of the screen voltage circuit is illustrated as being referenced to the ground. The voltage multiplier of the screen voltage circuit may also be referenced to the MCP voltage.

FIG. 6B illustrates a diagram of an exemplary switching voltage circuit 610 with auto-gating control, in accordance with an embodiment of the present invention. The auto-gating controller 603 controls the photocathode current to a constant value by controlling the gating duty cycle of the photocathode current switch(es) 604. The voltage multiplier of the photocathode voltage circuit is illustrated as being referenced to the ground. The voltage multiplier of the photocathode voltage circuit may also be referenced to the MCP voltage.

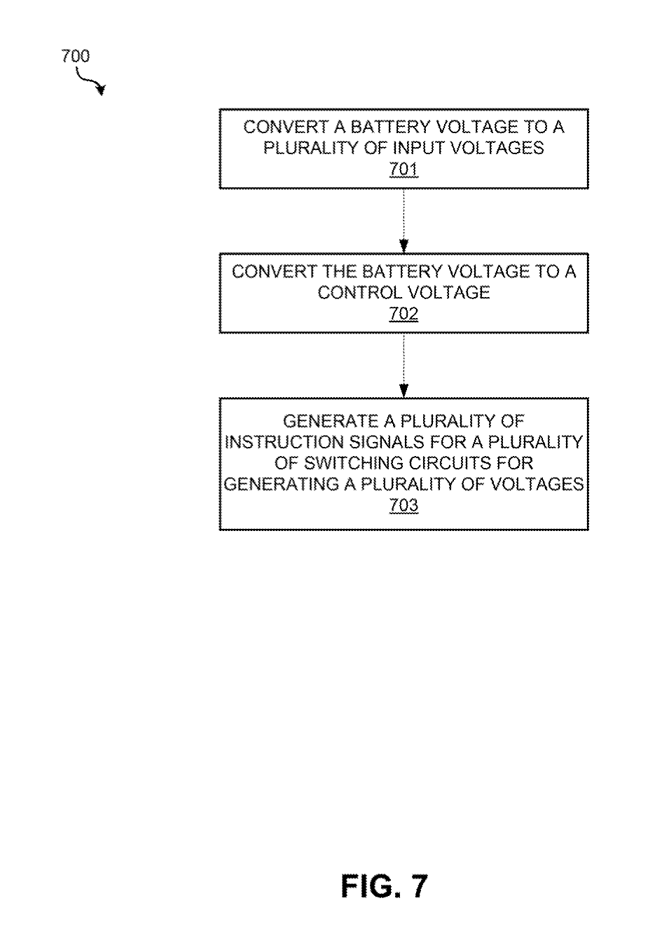

FIG. 7 illustrates a flow chart of an exemplary method 700 of powering a night vision device using switching circuits, in accordance with an embodiment of the present invention. At step 701, the method converts a battery voltage to a plurality of input DC voltages to a plurality of switching circuits. At step 702, the method converts the battery voltage to a DC control voltage. At step 703, the method generates a plurality of instruction signals. The instruction signals instruct switches of the plurality of switching circuits to turn on and off to generate output DC voltages, which power the night vision device.

In one embodiment, the method may compare a feedback voltage to a reference voltage when generating the instruction signals. In another embodiment, the method may regulate the screen current to a fixed value by altering the instruction signal to alter the MCP voltage. In a further embodiment, the method may regulate the photocathode current to a fixed value by altering the instruction signal to control the gating duty cycle.

The terms “less than,” “less than or equal to,” “greater than,” and “greater than or equal to,” may be used herein to describe the relations between various objects or members of ordered sets or sequences; these terms will be understood to refer to any appropriate ordering relation applicable to the objects being ordered.

As used herein, the term “module” might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A night vision system, comprising:
an image intensifier tube; and
a switching power supply comprising:
a first switching circuit generating a photocathode voltage and comprising a first switch for turning on and off a first input voltage in response to a first instruction signal;
a second switching circuit generating a micro-channel plate (MCP) voltage and comprising a second switch for turning on and off a second input voltage in response to a second instruction signal;
a third switching circuit generating a screen voltage and comprising a third switch turning on and off a third input voltage in response to a third instruction signal; and
a drive voltage regulator converting a battery voltage to the first input voltage, the second input voltage, and the third input voltage.

2. The night vision system of claim 1, wherein the switching power supply further comprises a high clamp voltage circuit providing a fixed direct circuit (DC) clamping photocathode voltage.

3. The night vision system of claim 1, wherein the switching power supply further comprises a control system comprising:
a first pulse width modulation (PWM) generator generating a first period pulse signal having a first duty cycle, the first PWM generator adjusting the first duty cycle based on a first difference between a reference photocathode voltage and a feedback photocathode voltage proportional to the photocathode voltage generated by the first switching circuit, the first periodic pulse signal being the first instruction signal;
a second PWM generator generating a second periodic pulse signal, the second periodic pulse signal being the second instruction signal; and
a third PWM generator generating a third periodic pulse signal having a third duty cycle, the third PWM generator adjusting the third duty cycle based on a third difference between a reference screen voltage and a feedback screen voltage proportional to the screen voltage generated by the third switching circuit, the third period pulse signal being the third instruction signal.

4. The night vision system of claim 3, wherein the control system maintains a constant photocathode current.

5. The night vision system of claim 3, wherein the control system controls the MCP voltage to maintain a constant screen current.

6. The night vision system of claim 3, wherein the switching power supply further comprises a control voltage regulator converting the battery voltage to a control voltage for powering the control system.

7. The night vision system of claim 1, wherein the first switch, the second switch, and the third switch are field-effect transistors (FETs).

8. The night vision system of claim 1, wherein the screen voltage is referenced to the MCP voltage and the photocathode voltage is referenced to ground.

9. The night vision system of claim 1, wherein the screen voltage is referenced to ground and the photocathode voltage is referenced to the MCP voltage.

10. A night vision device, comprising:
an image intensifier tube comprising
a photocathode,
a micro-channel plate (MCP), and
a screen; and
a switching power supply coupled to the image intensifier tube, comprising:
a first switching circuit generating a photocathode voltage and comprising a first switch for turning on and off a first input voltage in response to a first instruction signal, the first switching circuit coupled to the photocathode;
a second switching circuit generating an MCP voltage and comprising a second switch for turning on and off a second input voltage in response to a second instruction signal, the second switching circuit coupled to the MCP;
a third switching circuit generating a screen voltage and comprising a third switch turning on and off a third input voltage in response to a third instruction signal, the third switching circuit coupled to the screen; and
a drive voltage regulator converting a battery voltage to the first input voltage, the second input voltage, and the third input voltage, the drive voltage regulator coupled to the first switching circuit, the second switching circuit, and the third switching circuit.

11. The night vision device of claim 10, wherein the switching power supply further comprises:
a first pulse width modulation (PWM) generator coupled to the first switch, generating a first periodic pulse signal having a duty cycle in accord with a first difference between a reference photocathode voltage and a feedback photocathode voltage proportional to the photocathode voltage generated by the first switching circuit, the first periodic pulse signal being the first instruction signal;
a second PWM generator coupled to the second switch, generating a second periodic pulse signal, the second periodic pulse signal being the second instruction signal; and
a third PWM generator coupled to the third switch, generating a third periodic pulse signal having a duty cycle in accord with a third difference between a reference screen voltage and a feedback screen voltage proportional to the screen voltage generated by the third switching circuit, the third period pulse signal being the third instruction signal.

12. The night vision device of claim 11, wherein the first instruction signal is proportional to a photocathode current and the third instruction signal is proportional to a screen current.

13. The night vision device of claim 11, wherein the switching power maintains a constant photocathode current.

14. The night vision device of claim 11, wherein the switching power supply controls the MCP voltage to maintain a constant screen current.

15. The night vision device of claim 1, wherein the first switch, the second switch, and the third switch are field-effect transistors (FETs).

16. The night vision device of claim 1, wherein the screen voltage is referenced to the MCP voltage and the photocathode voltage is referenced to ground.

17. The night vision device of claim 1, wherein the screen voltage is referenced to ground and the photocathode voltage is referenced to the MCP voltage.

18. A method of powering a night vision device, comprising:
converting a battery voltage to a first input voltage, a second input voltage, and a third input voltage;
generating a first instruction signal to a first switching circuit comprising a first switch for turning on and off the first input voltage in response to the first instruction signal, the first switching circuit generating a photocathode voltage for powering a photocathode of the night vision device;
generating a second instruction signal to a second switching circuit comprising a second switch for turning on and off the second input voltage in response to the second instruction signal, the second switching circuit generating a micro-channel plate (MCP) voltage for powering an MCP of the night vision device; and
generating a third instruction signal to a third switching circuit comprising a third switch or a third plurality of switches for turning on and off the third input voltage in response to the third instruction signal, the third switching circuit generating a screen voltage for powering a screen of the night vision device.

19. The method of claim 18, further comprising:
generating a first periodic pulse signal having a duty cycle in accord with a first difference between a reference photocathode voltage and a feedback photocathode voltage proportional to the photocathode voltage generated by the first switching circuit, the first periodic pulse signal being the first instruction signal;
generating a second periodic pulse signal, the second periodic pulse signal being the second instruction signal; and
generating a third periodic pulse signal having a duty cycle in accord with a third difference between a reference screen voltage and a feedback screen voltage proportional to the screen voltage generated by the third switching circuit, the third periodic pulse signal being the third instruction signal.

20. The method of claim 18, further comprising providing a user with a selection of automatic brightness control set points.
